(19) United States
(12) Patent Application Publication
(10) Pub. No.: US 2006/0270435 A1
(43) Pub. Date: Nov. 30, 2006

(54) Method of controlling power

(75) Inventors: Svetlana Chemiakina, Norresundby (DK); Jeroen Wigard, Klarup (DK)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/352,256

(22) Filed: Feb. 13, 2006

(30) Foreign Application Priority Data
May 31, 2005 (GB) GB 0511058.0

(51) Int. Cl. H04B 7/00

(52) U.S. Cl. 455/522; 455/69

(57) ABSTRACT

A method of controlling power of a data channel, said method comprising the steps of defining for said channel a target value for a layer 1 block error rate L1 BLER and controlling the power of said data channel based on said target value.

### BACKGROUND TO THE INVENTION

1. Field of the Invention

The present invention relates to a method of controlling power of a data channel and in particular but not exclusively to controlling the power of an enhanced dedicated channel (E-DCH). The present invention also relates to a node for controlling power of a data channel.

2. Description of the Related Art

A mobile communication system is an example of a system in which an access network is provided to allow access to the system functionality for user terminals.

In a Universal Mobile Telecommunications System (UMTS), a radio access network typically provides access for user equipment to a mobile communications system network. The user equipment typically communicates with the access network over a radio interface, the access network including a plurality of node Bs or base stations or more generally network access points, with which the user equipment establishes a connection. Each of the nodes Bs is connected to one or more radio network controllers RNCs, or more generally network access controllers.

In the third generation partnership project technical specification group radio access network (3GPP-TSG-RAN) there has been proposed high-speed uplink packet access also known in 3GPP as frequency division duplex (FDD) enhanced uplink, including an enhanced DCH, E-DCH. This proposal is documented in 3GPP-TR25.896.

The E-DCH is a transport channel. Also proposed are an uplink enhanced dedicated physical data channel (uplink E-DPDCH), and an uplink enhanced dedicated physical control channel (uplink E-DPCCH.) There may be zero, one, or several uplink E-DPDCHs on each radio link. It is currently proposed that no more than one DPDCH should be supported at the same time as one or more E-DPDCHs are supported.

A proposed functionality of the E-DCH is a hybrid automatic repeat request (H-ARQ) error detection correction mechanism. The error control mechanism is proposed to be implemented in the node B MAC-e unit packets. In such an implementation, it is proposed to provide an E-DCH HARQ ACK indicator channel (E-HICH) for the network access point to transmit an indication of an error free receipt of a data packet. The network access point transmits an acknowledgment ACK or non-acknowledgment NACK signal on the E-HICH independence on the outcome of the HARQ error detection mechanism.

The E-DPDCH relies on transport format related information carried on the E-DPCCH for demodulation and decoding. The uplink E-DPCCH is preferably a fixed rate uplink physical channel used to carry uplink signalling related to the E-DPCH.

The E-DCH is a power controlled channel. One implementation considered by the inventors is that when the DCH is present, the outer loop power control (OLPC) should run based on the DCH block error rate (BLER) as described in release 99 of the 3GPP specification. The E-DCH quality is controlled by adjusting the E-DCH power offset with respect to the DPCCH channel (using Beta factors). The Beta factors are:

$${β}_{ed} = {β}_{c} \cdot {10}^{( \frac{{Δ}_{E - DPDCH}}{20} )}$$

As described in 4.2.1.1 of 3GPP Technical specification 25.213: After channelization, the real-valued spread signals are weighted by gain factors, β_{c} for DPCCH, β_{d} for all DPDCHs.

Δ_{E-DPDCH} is the gain factor.

When the DCH is not present, the outer loop power control runs on the E-DCH quality which is used as a target to adjust the SIR target (signal interference ratio) and/or E-DCH Beta factors.

However, due to the nature of the HARQ protocol, it is not optimal to use the E-DCH residual block error rate as an E-DCH quality target for the E-DCH outer loop power control as in the DCH case. The reason for this is that is possible to reduce the residual BLER close to 0% and thus some more information from the HARQ operation is needed in order to be able to tune how many time each packet has been transmitted.

It is an aim embodiment for the present invention to address the above described problems

### SUMMARY OF THE INVENTION

According to one aspect of the invention, there is provided a method of controlling power of a data channel, said method comprising the steps of:

defining for said channel a target value for a layer 1 block error rate L1 BLER; and

controlling the power of said data channel based on said target value.

According to another aspect of the invention, there is provided a node in a communications system arranged to controlling the power of a data channel, said node being arranged to define for said channel a target value for a layer 1 block error rate L1 BLER and to control the power of said data channel based on said target value.

### BRIEF DESCRIPTION OF THE FIGURES

For a better understanding of the present invention and as to how the same may be carried into effect, reference will now be made by way of example only to the accompanying drawings in which;

FIG. 1 illustrates an exemplary radio access network in which embodiments of the present invention can be incorporated;

FIG. 2 is a schematic diagram illustrating the method embodying the present invention; and

FIG. 3 shows schematically the modulation of data in embodiments of the invention.

### DETAILED DESCRIPTION OF PREFERRED EMBODIMENTS OF THE INVENTION

The embodiments of the present invention are described by way of reference to particular example scenarios. In particular, embodiments are described in relation to a universal mobile telecommunication system (UMTS). However, it should be appreciated that the invention is not, however, limited to this specific such embodiments and one skilled in the art will recognise the broad applicability of the invention.

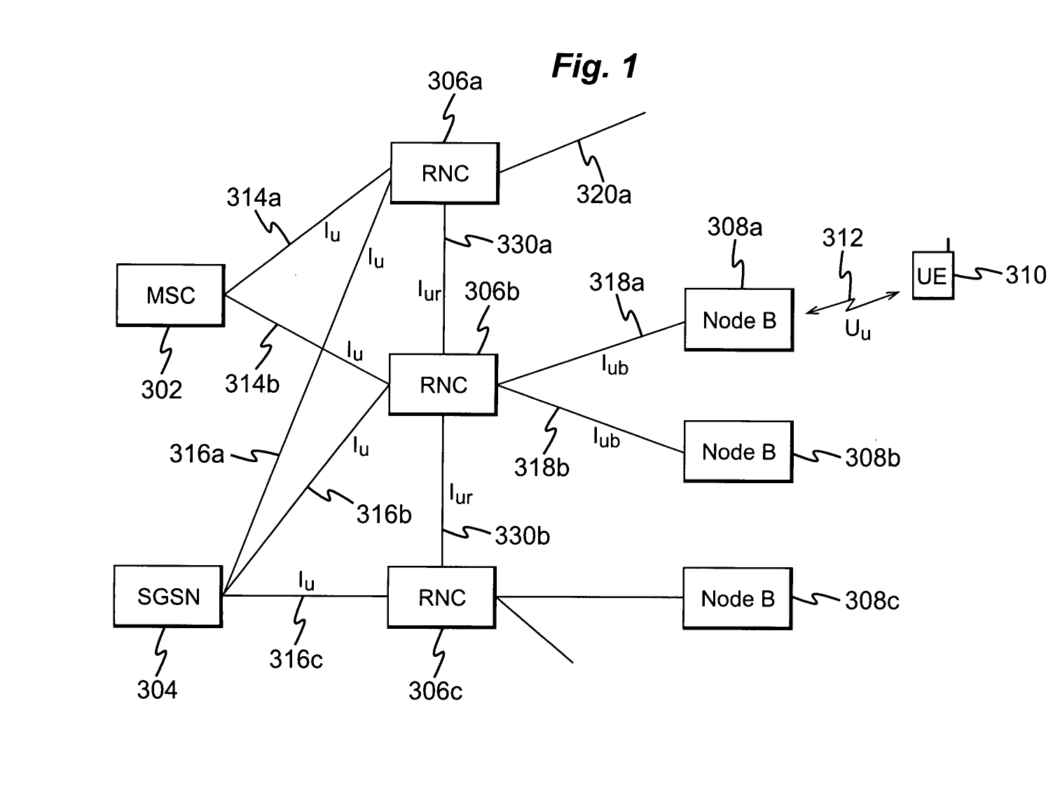

Referring to FIG. 1, an example UMTS system may typically include a mobile switching center (MSC) 302, a serving GPRS support node (SGSN) 304, a plurality of radio network controllers (RNCs) 306a, 306b, 306c, a plurality of node Bs 308a, 308b, 308c and at least one user equipment (UE) 310.

In practice, the MSC functionality may be provided by an MSC server (MSS) and a media gateway (MGW). As it is known in the art, the at least one user equipment 310 connects with one of the node Bs for example node B 308a, over a radio interface 312, known in the 3GPP UMTS system as a Uᵤ interface.

Each node B is connected to at least one RNC via a I_{ub} interface. The RNC 306b connects to the node Bs 308a and 308b via the I_{ub} interfaces 318a and 318b respectively, and possibly to one or more other node Bs. The RNC 306c connects to the node B 308c via the I_{ub} interface 322a, and to one or more other node Bs via one or more other I_{ub} interfaces, such as interface 322b. The RNC 306a connects to one or more node Bs via one or more I_{ub} interfaces, such as interface 320a. Various RNCs may connect to the various node Bs, as known in the art.

The RNCs themselves are interconnected via I_{ub} interfaces. In FIG. 1, it is shown that the RNC 306a is connected to the RNC 306b via an I_{ub} interface 330a, and the RNC 306b is connected to the RNC 306c via an I_{ub} interface 330b. The RNCs 306a and 306c may similarly be interconnected via the I_{ub} interface. The various RNCs may be connected via the I_{ub} interface.

Each of the RNCs and the UMTS system is connected to one or more MSCs or SGSNs via an I_{ub} interface. In the example of FIG. 1, the MSC 302 is connected to the RNCs 306a and 306b via respective I_{ub} interfaces 314a and 314b, and the SGSN 304 is connected to the RNCs 306a, 306b and 306c via respective I_{ub} interfaces 314a, 314b and 314c.

The enhanced DCH uplink transport channel is a channel for transporting traffic from a user equipment to a node B via the air interface I_{ub}, and for transporting from a node B to a RNC, and between RNCs on the I_{ub} interface or the Iᵤᵣ interface.

The hybrid automatic repeat request (H-ARQ) error control mechanism is used in various node Bs in embodiments of the present invention.

In the described embodiment, the node B generally may be considered to be a network access point, being a point which the user terminals such as a user equipment or mobile terminal accesses a network. In general, the radio network controller may be considered to be a network access controller, being an element which controls network access.

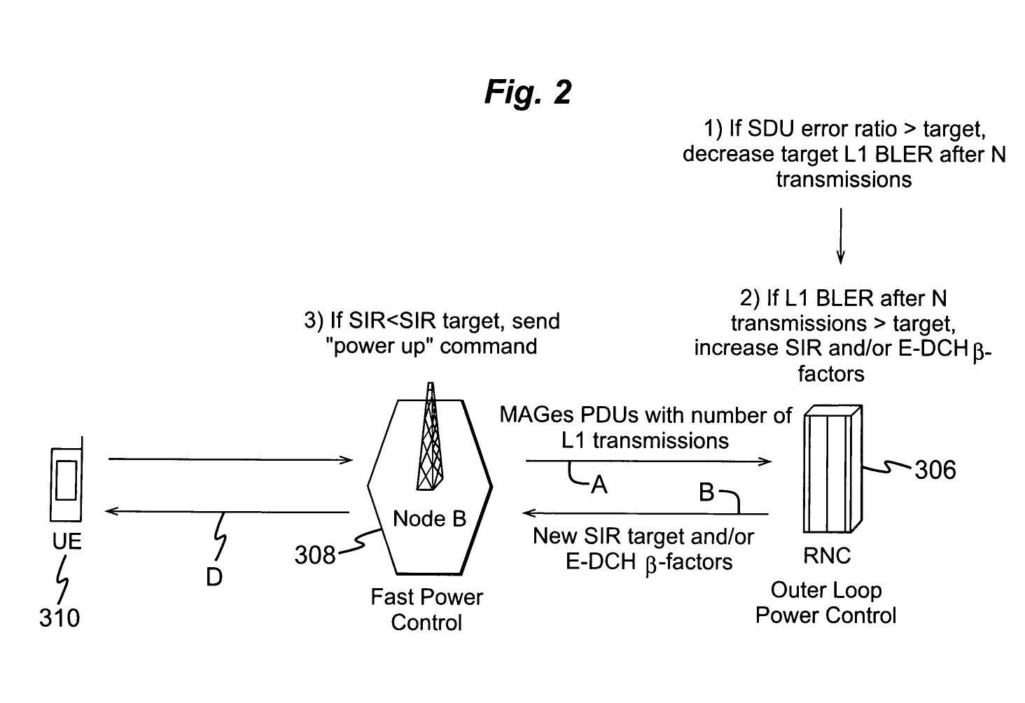

Reference is now made to FIG. 2 which schematically illustrates the method embodying the present invention. The same reference numbers as used in the description of FIG. 1 are used here. In particular, user equipment 310 is connected via an air or radio interface with a node B 308 which is in turn connected to a RNC 306. In embodiment of the present invention, the layer 1 block error rate (L1 BER) after N HARQ transmissions (when N is smaller than the maximum number of retransmissions) is used as it takes into account the HARQ information. Embodiments to the present invention provide a method of selecting the optimal operation point for an outer loop power control algorithm i.e. for selecting the optimal target L1 BLER after N retransmissions value in such way to be able to guarantee or at least try to meet the required SDU Service Data Unit error ratio and delay at the RLC radio link level.

Power control inner plus outer loop PC. Inner loop PC of the EDCH (both E-DPDCH and E-DPCCH) are running the same inner loop as the DPCCH does (i.e. when the DPCCH powers up 1 dB the E-DPDCH and E-DPCCH do the same, etc.). The DPCCH is going up and down based a comparison between the measured SIR on the DPCCH and the target SIR. The target SIR is adjusted on a slow basis by the outer loop PC

Thus, in embodiments of the present invention, the RLC delay and SDU error ratio (that is the BLER after the RLC retransmission and re-assembling) is used along with the delay requirement in order to adjust the L1 BER target after N retransmissions. This is effectively the target value for the E-DCH quality. This value is used by the outer loop power control. This means that the operator is able to dynamically control the SDU error rate show and transfer delay provided to the end user.

At the service setup, the RNC 306 defines for each service that maps onto the E-DCH the target value of the L1 BLER after N transmissions. It should be appreciated that the set target value will have two parts. In particular the value of N is set as well as the value of the L1 block error rate.

In one embodiment of the present invention, the RNC use pre-stored tables either stored in the RNC or in a different entity. These pre-defined tables allow the selection of the target value taking into account one or more of the following:

traffic class,

delay,

SDU error ratio requirements.

It should be appreciated that whilst preferred embodiments of the present invention use pre-stored tables, the RNC could carry out a algorithm or instruct a different entity to perform an algorithm based on input parameters such as the traffic class, delay, SDU error ratio requirements.

The selected value is then used as a target based on which the outer look power control adjusts the target signal to interference ratio and/or the E-DCH Beta factors. The Beta Factor is as defined previously. The adjustment of the SIR target and/or E-DCH Beta factors based on the current target value of the L1 BLER after N transmissions takes place in the RNC based on information received from node B 308. UE sends the RSN to the Node B over the E-DPCCH, Node B tracks that and rebuilds the RSN and puts it on the FP frame. This is described in 3GPP technical specification TS25.427.

This is referenced by the movement of data between node B and RNC 306—See arrow A.

During the service, the RNC monitors the RLC level transfer delay and SDU error ratio. If these parameters do not correspond to the quality of service requirements, the RNC adjusts the L1 BLER target after N transmission values used as the OLPC target. For example if the delay is more than required, the N value indicating a number of retransmissions could be reduced, or if the SDU ratio is more than the required, the L1 BLER target value could be increased.

In terms of the arrangement shown in FIG. 2, step 1 represents the RNC making a determination that if the SDU error ratio is greater than the target, then the target L1 BLER after N transmissions is decreased.

On the other hand, the step marked 2 is carried out if the L1 BLER after N transmission is greater than the target, then the SIR and/or E-DCH Beta Factors are increased. The new SIR target and/or E-DCH Beta Factors are sent as marked by arrow B from the RNC to node B 308.

The node B carries out a comparison between the signal interference ratio of the target as compared to the actual signal to interference ratio. If the signal interference ratio is less than the target, then a power up command is sent as indicated by arrow D from node B 308 to user equipment 310.

The QoS Quality of Service is expressed with parameters. Logically this would be a target BLER, but it can be defined as broad as required. The SDU error ratio can thus be compared to the target or the QoS.

Embodiments of the present invention have the advantage that the operator is able to control the SDU ratio and transport delay for services mapped on to the E-DCH. The system capacity may be increased as the OLPC does not permit the provision of a better than required quality of service. Furthermore, no I_{ub} or air interface signalling is required as all the processing can take place in the RNC. It should be appreciated the number of needed transmissions is a parameter which is sent over the I_{ub}.

The RLC SDU is a data unit given to the RLC layer by an upper layer for transmission. These SDUs can be further segmented by the RLC into the RLC PDU packet data unit. These blocks are also called transport blocks. The SDU error ratio is the error ratio at the RLC level after transmission and re-assembly of the PDUs in the original SDU service data unit. The SDU delay is time used by the network to transmit the RLC SDU between the RNC and UE.

The L1 BLER is a block error rate at the HARQ level. It means that the transport block can be retransmitted between the UE and node B at the layer 1 before delivery to the transport block TB to the upper layers RLC. This differs from the normal DCH approach used by the prior art where retransmissions are performed at the RLC level between the UE and the RNC. The BLER as seen by HARQ mechanism is called the L1 BLER.

L1 means that the retransmissions are done between NodeB and UE and not between RNC and UE, ergo a shorter round trip time.

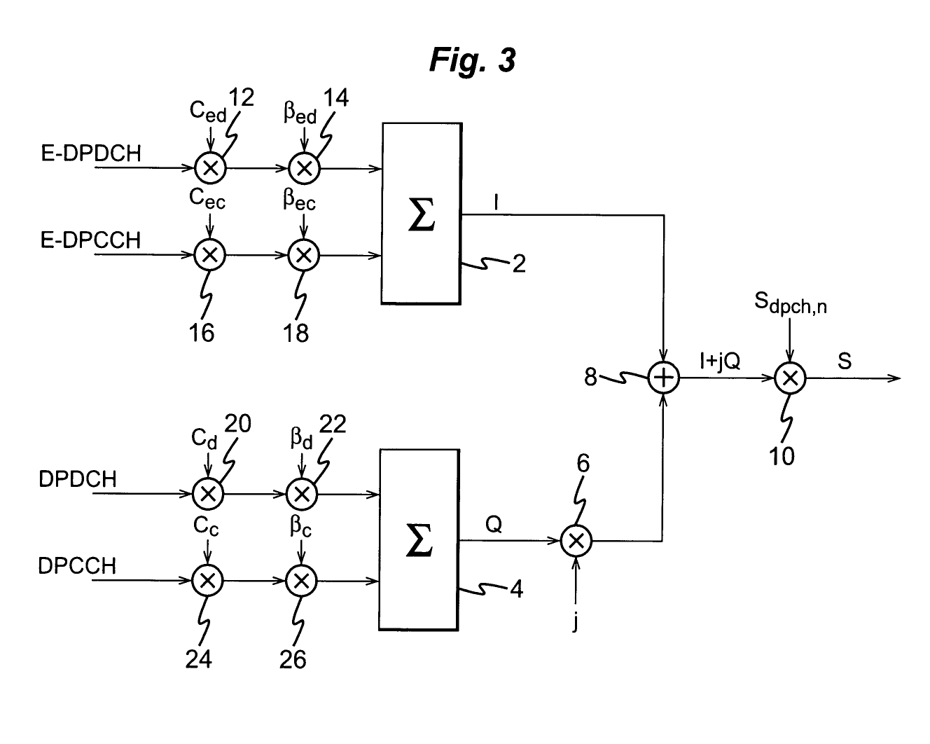

Reference is now made to FIG. 3 which shows the uplink code multiplexing in an E-DCH system which will typically take place in the node B and user equipment.

In an embodiment of the present invention, the DPCH is modulated on the Q component and E-DPDCH is modulated onto the I component. It may of course be the other way round. In particular, the E-DPDCH data is input to mixer 12 which mixes the data with the required code. The output is then input to a second mixer 14 which mixes the coded data with the relevant Beta factors. This is input to a summer 2. In the same way, the E-DPCCH data is input to mixer 16 where it is mixed with the corresponding code. The output is input to a further mixer 18 where it is mixed with the relevant Beta factor. The output is also input to the summer 2. The output of the summer represents the modulated I component of the signal which is input to an adder 8.

Similarly, the DPDCH data is mixed in mixer 20 with the appropriate code which in turn is output to a further mixer 22 where the Beta factors are mixed. The output of that further mixer 22 is input to a second summer 4. The DPCCH data is mixed with the respective code in mixer 24, the output of which is input to mixer 26 where the Beta factors are mixed in. The output of mixer 26 is input to the second summer 4. The output of the summer provides the Q component which is input to a further mixer 6 which introduces the j component. Thus, the input to adder 8 is the I component and the jQ component. These are added together and output to a further mixer 10 which introduces the frequency at the signal S is to be transmitted.

The invention has been described here by way of example, with reference to preferred but non limiting examples. If should be noted that the invention is not limited details of the embodiments, and the scope of protection is defined by the appended claims. The description may also lie in the specific of any embodiment described herein, as defined in the appended claims.

1. A method of controlling power of a data channel, said method comprising the steps of:
defining for said data channel a target value for a layer 1 block error rate; and
controlling the power of said data channel based on said target value.

2. The method as claimed in claim 1, wherein said defining step comprises defining the target value for each service mapped onto said data channel.

3. The method as claimed in claim 1, wherein said defining step comprises defining said target value of the layer 1 block error rate after N transmissions where N is less than a maximum number of transmissions.

4. The method as claimed in claim 1, wherein said defining step takes place in a radio network controller.

5. The method as claimed in claim 1, wherein said defining step comprises using a table.

6. The method as claimed in claim 1, wherein in said defining step, the target value is dependent on at least one of traffic class, delay, error ratio requirements and Service Data Unit error ratio requirements.

7. The method as claimed in claim 1, wherein in said controlling step, outer loop power control is used.

8. The method as claimed in claim 1, wherein in said controlling step, based on said target value, controlling at least one of a target signal to interference ratio and a beta factor.

9. The method as claimed in claim 8, wherein said beta factor is defined by
$${β}_{ed} = {β}_{c} \cdot {10}^{( \frac{{Δ}_{E - DPDCH}}{20} )} .$$

10. The method as claimed in claim 1, further comprising the step of monitoring at least one parameter of said data channel.

11. The method as claimed in claim 10, wherein said at least one parameter comprises at least one of: transfer delay; RLC level transfer delay; error ratio; and Service Data Unit error ratio.

12. The method as claimed in claim 1, comprising the step of adjusting said target value in dependence on a service requirement.

13. The method as claimed in claim 12, wherein said service requirement is a quality of service requirement.

14. The method as claimed in claim 10, comprising the step of adjusting said target value in dependence on a service requirement, wherein said adjusting step is configured to adjust said target value in dependence on a value of said at least one parameter.

15. The method as claimed in claim 1, wherein said data channel is an enhanced dedicated channel

16. A node in a communications system configured to control the power of a data channel, said node being configured to define for said data channel a target value for a layer 1 block error rate and to control the power of said data channel based on said target value.

17. The node as claimed in claim 16, wherein said node is a radio network controller.

18. The node as claimed in claim 16, wherein said node is configured to define the target value for each service mapped onto said data channel.

19. The node as claimed in claim 16, wherein said node is configured to define said target value of the layer 1 block error rate after N transmissions where N is less than a maximum number of transmissions.

20. The node as claimed in claim 16, wherein a memory is provided to store a table containing target values.

21. The node as claimed in claim 16, wherein the target value is dependent on at least one of traffic class, delay, error ratio requirements and Service Data Unit error ratio requirements.

22. The node as claimed in claim 16, wherein said node uses outer loop power control to control the power.

23. The node as claimed in claim 16, wherein said node is configured to control, based on said target value, at least one of a target signal to interference ratio and a beta factor.

24. The node as claimed in claim 23, wherein said beta factor is defined by
$${β}_{ed} = {β}_{c} \cdot {10}^{( \frac{{Δ}_{E - DPDCH}}{20} )} .$$

25. The node as claimed in claim 16, further comprising means for monitoring at least one parameter of said data channel.

26. The node as claimed in claim 25, wherein said at least one parameter comprises at least one of transfer delay, RLC level transfer delay, error ratio, and Service Data Unit error ratio.

27. The node as claimed in claim 16, comprising means for adjusting said target value in dependence on a service requirement.

28. The node as claimed in claim 27, wherein said service requirement is a quality of service requirement.

29. A node as claimed in claim 25, comprising means for adjusting said target value in dependence on a service requirement, wherein said adjusting means is configured to adjust said target value in dependence on a value of said at least one parameter.

30. The node as claimed in claim 16, wherein said data channel is an enhanced dedicated channel

31. A system of controlling power of a data channel, said system comprising:
means for defining for said data channel a target value for a layer 1 block error rate; and
means for controlling the power of said data channel based on the target value.

32. A radio network controller in a communications system configured to control the power of a data channel, said radio network controller being configured to define for said data channel a target value for a layer 1 block error rate and to control the power of said data channel based on said target value.
